(19) United States
(12) Patent Application Publication
(10) Pub. No.: US 2023/0234084 A1
(43) Pub. Date: Jul. 27, 2023

(54) Film Forming Apparatus, Film Forming Method, and Formed Film

(71) Applicants: Osaka Gas Co., Ltd., Tokyo (JP); National institute of advanced industrial science and technology, tokyo (JP)

(72) Inventors: Kyohei Manabe, Osaka-shi (JP); Katsuki Higaki, Osaka-shi (JP); Hisao Ohnishi, Osaka-shi (JP); Mitsuaki Echigo, Osaka-shi (JP); Tadayuki Sogi, Osaka-shi (JP); Jun Akedo, Tsukuba-shi (JP); Rintaro Aoyagi, Tsukuba-shi (JP); Hiroaki Matsui, Tsukuba-shi (JP); Kentaro Shinoda, Tsukuba-shi (JP); Hiroki Tsuda, Tsukuba-shi (JP)

(21) Appl. No.: 17/916,077

(22) PCT Filed: Mar. 31, 2021
(86) PCT No.: PCT/JP2021/013833

§ 371 Date: Apr. 6, 2023

(30) Foreign Application Priority Data
Mar. 31, 2020 (JP) 2020-065154

(51) Int. Cl. B05B 7/00; B05B 16/60; B05B 7/14; C23C 24/04

(52) U.S. Cl. CPC B05B 7/0012; B05B 16/60; B05B 7/1404; B05B 7/1486; C23C 24/04

(57) ABSTRACT

Provided is a film forming apparatus capable of stably supplying a large amount of ceramic raw material powder for a long time and forming a homogeneous and dense film. A film forming apparatus 1 for forming a film on a base material K includes an aerosol transport path 10 for ejecting an aerosol obtained by dispersing a ceramic raw material powder in a gas, from an ejection end 10a toward the base material K, in which a flow path cross-section at an ejection end 10a of the aerosol transport path 10 has a substantially circular shape with an area of 10 mm² or more.

### CROSS-REFERENCE TO RELATED APPLICATIONS

This application is the United States national phase of International Application No. PCT/JP2021/013833 filed, Mar. 31, 2021, and claims priority to Japanese Patent Application No. 2020-065154 filed Mar. 31, 2020, the disclosures of which are hereby incorporated by reference in their entirety.

### BACKGROUND OF THE INVENTION

### Field of the Invention

The present invention relates to a film forming apparatus and a film forming method for forming a film on a base material, and a formed film.

### Description of Related Art

A technique called the aerosol deposition method (AD method) is a method for forming a film made of a metal oxide material on a base material without undergoing a high-temperature heat treatment such as sintering. The AD method is a method of forming a film on a base material by spraying a raw material powder made of minute particles such as a metal oxide from a nozzle toward the base material such as ceramic or plastic at about the speed of sound to crush and deform the minute particles using the energy obtained when the raw material powder collides with the base material.

As an apparatus used in the AD method, for example, a film forming apparatus described in Patent Document 1 has been proposed. The film forming apparatus described in Patent Document 1 includes an aerosol generating section that generates an aerosol obtained by mixing a raw material powder and a carrier gas, a nozzle that sprays the aerosol from a spray port, and the like, and the aerosol can be sprayed from the spray port of the nozzle toward the base material to form a film on the base material. Patent Document
Patent Document 1: Japanese Patent Application Laid-Open No. 2007-246937

In the AD method, the impact force of the minute particles colliding with the base material has a significant effect on the density of the film, and therefore in order to obtain a desired homogeneous film quality, the speed of the minute particles colliding with the base material needs to be controlled within an appropriate range. In particular, zirconia-based materials have high hardness, are less likely to undergo brittle deformation when colliding with a base material, and have a very narrow process window for film formation. For this reason, in order to form a homogeneous film, it is necessary to control the speed of the particles with high accuracy.

The film forming apparatus described in Patent Document 1 uses a nozzle with a small opening area and a diaphragm, or a nozzle with a rectangular flow path cross-section. However, when a nozzle with a small opening area and a diaphragm is used, the carrier gas component of the aerosol is rapidly accelerated at the ejection end of the nozzle, and therefore with a zirconia-based material that has a relatively high specific gravity, the particles cannot fully keep up with the acceleration of the carrier gas and collide with the base material at a low speed. As a result, there is a problem that a porous region having a low film density is generated, making it difficult to obtain a dense film. Also, if a nozzle with a rectangular flow path cross-sectional shape is used, there is a problem in that the gas flow is likely to be disturbed at the edges of the rectangle and the like, resulting in non-uniform gas speeds and consequently non-uniform particle speeds, and therefore it is difficult to obtain a homogenous film. Furthermore, if a nozzle with a relatively small opening area is used, there is a problem in that when a large amount of raw material powder is supplied for a long time, the raw material powder tends to accumulate inside the nozzle, and the accumulated raw material powder is ejected, whereby powder compact formation frequently occurs in which minute particles accumulate without being crushed or deformed at the time of collision with the base material, and thus defects occur in the film, making it unsuitable for mass production.

### SUMMARY OF THE INVENTION

The present invention has been made in view of the above circumstances, and aims to provide a film forming apparatus and film forming method capable of stably supplying a large amount of ceramic raw material powder for a long time and forming a homogeneous and dense film, and a formed film.

A characteristic configuration of the film forming apparatus according to the present invention for achieving the above object is a film forming apparatus for forming a film on a base material, including

an aerosol transport path for ejecting an aerosol obtained by dispersing a ceramic raw material powder in a gas, from an ejection end toward the base material,

in which a flow path cross-section at the ejection end of the aerosol transport path has a substantially circular shape with an area of 10 mm² or more.

In addition, a characteristic configuration of the film forming method according to the present invention for achieving the above object is a film forming method for forming a film on a base material by ejecting an aerosol obtained by dispersing a ceramic raw material powder in a gas, from an ejection end of an aerosol transport path toward the base material,

Wherein ejecting the aerosol toward the base material from the ejection end has a flow path cross-section that has a substantially circular shape with an area of 10 mm² or more.

According to the above characteristic configuration, the flow speed of the aerosol at the ejection end becomes uniform within the flow path cross-section due to making the cross-sectional shape of the ejection end of the aerosol transport path substantially circular. For this reason, a homogeneous and dense film can be formed on the base material. In addition, since the flow path cross-sectional area (area of the flow path cross-section) at the aerosol ejection end of the aerosol is 10 mm² or more, the flow path cross-sectional area at the ejection end is significantly larger than before, the ceramic raw material powder is less likely to accumulate inside the aerosol transport path, and a large amount of ceramic raw material powder can be stably supplied for a long time. Furthermore, by increasing the flow path cross-sectional area, the gas component of the aerosol is gradually accelerated in the flow path, and therefore, in particular, particles of even zirconia-based raw material powder that has a relatively large specific gravity are more likely to keep up with the acceleration of the gas. For this reason, it is possible to cause particles having a sufficient speed for obtaining a dense film to collide with the base material.

In another characteristic configuration of the film forming apparatus and film forming method according to the present invention, a distance from the ejection end of the aerosol transport path to the base material is 100 mm or less.

Since the aerosol ejected from the ejection end of the aerosol transport path spreads and is dispersed, the surface area of the film formed on the base material increases as the distance from the ejection end of the aerosol transport path to the base material increases. If the surface area formed on the base material increases, it is necessary to form the film over a wider surface area than the target film forming surface area when scanning the aerosol transport path or the base material to obtain a homogeneous film. Upon doing so, the amount of raw material powder used will increase, and there is a risk that the production cost will rise. According to the above characteristic configuration, due to the distance from the ejection end of the aerosol transport path to the base material being 100 mm or less, it is easier to suppress an increase in the production cost.

In another characteristic configuration of the film forming apparatus and film forming method according to the present invention, a value obtained by dividing the area of the flow path cross-section at the ejection end of the aerosol transport path by a square of a distance between the ejection end of the aerosol transport path and the base material is 0.001 or more.

According to the above characteristic configuration, the value obtained by dividing the flow path cross-sectional area at the ejection end of the aerosol transport path by a square of a distance between the ejection end of the aerosol transport path and the base material is 0.001 or more, whereby the particle speed in the direction perpendicular to the base material at the time of colliding with the base material is less likely to vary, and therefore it is possible to suppress adhesion of a powder compact and formation of porosity, and it is possible to form a homogeneous film.

Another characteristic configuration of the film forming apparatus according to the present invention includes a processing chamber with an inner space in which at least a portion on a side of the ejection end of the aerosol transport path and the base material are arranged,

in which a flow path cross-section of the aerosol transport path at a processing chamber internal transport section located in the processing chamber has a substantially circular shape with an area of 10 mm² or more.

Also, another characteristic configuration of the film forming method according to the present invention includes arranging at least a portion on a side of the ejection end of the aerosol transport path and the base material in an inner space of a processing chamber, and

ejecting the aerosol toward the base material from the ejection end of the aerosol transport path in which a flow path cross-section at a processing chamber internal transport section located in the processing chamber has a substantially circular shape with an area of 10 mm² or more.

According to the above characteristic configuration, since the flow path cross-sectional area in the processing chamber internal transport section is substantially circular with a size of 10 mm² or more, the flowability of the aerosol is improved, and the ceramic raw material powder is less likely to accumulate in the aerosol transport path, and therefore a large amount of the ceramic raw material powder can be stably supplied for a long time.

In another characteristic configuration of the film forming apparatus and film forming method according to the present invention, the shape of the flow path cross-section at the processing chamber internal transport section corresponds to the shape of the flow path cross-section at the ejection end.

According to the above-described characteristic configuration, due to the shape of the flow path cross-section in the processing chamber internal transport section corresponding to the shape of the flow path cross-section at the ejection end, the flowability of the aerosol is improved, and the ceramic raw material powder is less likely to accumulate, and therefore a large amount of ceramic raw material powder can be stably supplied for a long time.

In another characteristic configuration of the film forming apparatus and film forming method according to the present invention, a pressure in the processing chamber is 0.6 kPa or less.

Since the gas component of the aerosol rapidly decelerates and is dispersed to the surrounding area when it collides with the base material, there is a risk that it will be difficult for the particles affected by this to reach the base material at a sufficient speed. According to the above characteristic configuration, since the viscosity of the gas component of the aerosol is reduced, the particles are less likely to be affected by the gas motion when colliding with the base material, and therefore a denser and more uniform film can be formed.

In another characteristic configuration of the film forming apparatus and film forming method according to the present invention, the aerosol transport path is constituted by a straight pipe member.

According to the above characteristic configuration, the shape of the flow path cross-section is the same over the entirety of the aerosol transport path. For this reason, the flowability of the aerosol is improved, the ceramic raw material powder is less likely to accumulate, and a large amount of the ceramic raw material powder can be stably supplied for a long time.

In another characteristic configuration of the film forming apparatus and film forming method according to the present invention, a density of particles constituting the ceramic raw material powder is 4.0 g/cm³ or more.

According to the above characteristic configuration, a homogeneous film can be formed based on the ceramic raw material powder constituted by particles having a density of 4.0 g/cm³ or more.

In another characteristic configuration of the film forming apparatus and film forming method according to the present invention, the ceramic raw material powder is stabilized zirconia.

The inventor of the present application has confirmed through experiment that a homogeneous film can be formed when stabilized zirconia is used as the ceramic raw material powder.

In a characteristic configuration of the formed film according to the present invention for achieving the above object, the formed film is formed by the above-mentioned film forming apparatus or through the above-mentioned film forming method.

According to the above characteristic configuration, since the film is formed by a film forming apparatus or through a film forming method capable of forming a homogeneous and dense film, the formed film is homogeneous and dense.

### BRIEF DESCRIPTION OF THE DRAWINGS

FIG. 1 is a diagram showing a configuration of a film forming apparatus according to an embodiment.

FIG. 2 is a view of an aerosol transport pipe according to the present embodiment viewed from a side of an ejection end.

FIG. 3 is a diagram showing a positional relationship between the aerosol transport pipe and the base material.

FIG. 4 is a diagram showing the ejection end of the film forming apparatus used in Comparative Example 1.

FIG. 5 is a diagram showing the ejection end of the film forming apparatus used in Comparative Example 2.

FIG. 6 is a diagram schematically showing a base material after film formation processing in Comparative Example 1.

FIG. 7 is a diagram schematically showing a base material after film formation processing in Comparative Example 2.

### DESCRIPTION OF THE INVENTION

Hereinafter, a film forming apparatus and a film forming method according to an embodiment of the present invention will be described with reference to the drawings.

Film Forming Apparatus

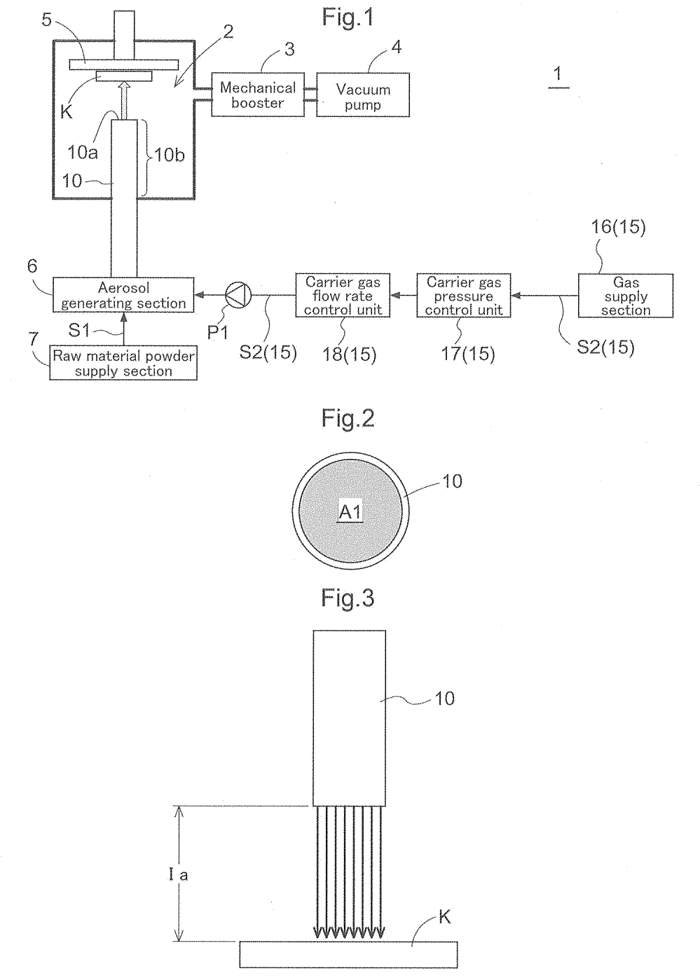

As shown in FIG. 1, the film forming apparatus according to this embodiment includes a processing chamber 2, an aerosol generating section 6, an aerosol transport pipe 10 (aerosol transport path), a carrier gas feeding means 15, and the like.

The processing chamber 2 is an airtight housing. The inside of the processing chamber 2 is depressurized to a predetermined pressure (e.g., about 0.6 kPa) or less by discharging gas by a mechanical booster pump 3 and a vacuum pump 4 serving as exhaust equipment. Also, in the inner space of the processing chamber 2, a holding section 5 for holding a base material K to be subjected to the film forming processing and part of the aerosol transport pipe 10 are arranged.

The aerosol generating section 6 is a device that generates an aerosol by dispersing ceramic raw material powder in gas. In this embodiment, the aerosol generating section 6 is connected to a raw material powder supply section 7 via a raw material supply pipe 51. Also, the aerosol generating section 6 is connected to a carrier gas feeding pipe S2 and the aerosol transport pipe 10, which will be described later. Also, in the aerosol generating section 6, an aerosol is generated by mixing the ceramic raw material powder supplied from the raw material powder supply section 7 at a constant speed and the carrier gas fed by the carrier gas feeding means 15. The generated aerosol is fed to the aerosol transport pipe 10. Note that the time it takes to form a film having a target thickness can be shortened by increasing the supply speed of the ceramic raw material powder supplied from the raw material powder supply section 7 to the aerosol generating section 6, but if the supply speed is too high, pulsation will occur in the supply amount of the raw material powder, making it difficult to obtain a homogeneous film. On the other hand, if the supply speed is too slow, the film quality is improved, but the time required to complete film formation increases, and thus the manufacturing cost increases. For this reason, the supply speed of the ceramic raw material powder is preferably 1.5 to 30 g/min.

As shown in FIGS. 1 to 3, the aerosol transport pipe 10 has an ejection end 10a and a processing chamber internal transport section 10b (at least a portion on a side of the ejection end), and the ejection end 10a is disposed in the processing chamber 2 in such a manner as to oppose the holding section 5 in the processing chamber 2. The aerosol transport pipe 10 in the present embodiment is a cylindrical straight pipe member having a flow path cross-sectional area A1 (shaded portion in FIG. 3) with a predetermined inner diameter, and the end portion opposite to the ejection end 10a is connected to the aerosol generating section 6. That is, in the aerosol transport pipe 10 of the present embodiment, the flow path cross-section in the processing chamber internal transport section 10b and the flow path cross-section at the ejection end 10a are both circular with the same flow path cross-sectional area A1. According to this aerosol transport pipe 10, the aerosol is fed from the aerosol generating section 6, and the fed aerosol is ejected from the opening of the ejection end 10a.

Next, the flow path cross-sectional area A1 at the ejection end 10a of the aerosol transport pipe 10, a distance Ia between the ejection end 10a of the aerosol transport pipe 10 and the base material K, and the relationship between the flow path cross-sectional area A1 and the distance Ia will be explained.

The flow path cross-sectional area A1 of the ejection end 10a of the aerosol transport pipe 10 is not particularly limited as long as it is 10 mm² or more, but is preferably 20 mm² or more, more preferably 30 mm² or more, and even more preferably 95 mm² or more. Note that in the present embodiment, the flow path cross-sectional area A1 is 95 mm².

The distance Ia from the ejection end 10a of the aerosol transport pipe 10 to the base material K is not particularly limited, but is preferably 100 mm or less, more preferably 40 mm or less, and even more preferably 10 mm or less. On the other hand, if the distance between the ejection end 10a of the aerosol transport pipe 10 and the base material K is too small, when the base material K has a distorted shape, there is a risk that the ejection end 10a and the base material K will come into contact with each other when the aerosol transport pipe 10 and the base material K are moved relative to each other, and therefore it is preferable that the distance Ia between the ejection end 10a of the aerosol transport pipe 10 and the base material K is 2 mm or more. Note that in this embodiment, the distance Ia is 10 mm.

Also, with the film forming apparatus 1, the value obtained by dividing the flow path cross-sectional area A1 at the ejection end 10a of the aerosol transport pipe 10 by a square of the distance Ia between the ejection end 10a of the aerosol transport pipe 10 and the base material K (hereinafter referred to as “(A1/Ia²) value”) is set to be 0.001 or more (that is, 95/10²=0.95 in the present embodiment). Note that although there is no particular limitation on the (A1/Ia²) value, it is preferably 0.001 or more, more preferably 0.007 or more, and even more preferably 0.03 or more. Also, the (A1/Ia²) value is preferably 25 or less, and more preferably 1 or less.

The carrier gas feeding means 15 includes a gas supply section 16, a carrier gas pressure control unit 17, a carrier gas flow rate control unit 18, a carrier gas feeding pipe S2, and the like.

Specifically, a carrier gas feeding pipe S2 is connected to the gas supply section 16, and the gas supply section 16 supplies gases such as air, N₂, He, and Ar to the carrier gas feeding pipe S2 using a compressor or a gas cylinder.

In this embodiment, the carrier gas feeding pipe S2 is for feeding the gas supplied from the gas supply section 16 to the aerosol generating section 6 as the carrier gas. Specifically, in the present embodiment, the gas sent from the gas supply section 16 is fed as the carrier gas to the aerosol generating section 6 via the carrier gas pressure control unit 17 and the carrier gas flow rate control unit 18 in the stated order, and the carrier gas feeding pipe S2 is constituted by a plurality of pipes connected between the gas supply section 16, the carrier gas pressure control unit 17, the carrier gas flow rate control unit 18, and the aerosol generating section 6.

Also, a pressure sensor P1 for detecting the pressure in the carrier gas feeding pipe S2 is provided between the carrier gas flow rate control unit 18 and the aerosol generating section 6 in the carrier gas feeding pipe S2.

The carrier gas pressure control unit 17 statically stabilizes the carrier gas flowing through the carrier gas feeding pipe S2 at an appropriate pressure, and the carrier gas flow rate control unit 18 controls the flow rate of the carrier gas flowing through the carrier gas feeding pipe S2. In this embodiment, the operations of the carrier gas pressure control unit 17 and the carrier gas flow rate control unit 18 are appropriately controlled based on the pressure detected by the pressure sensor P1 and the like.

Ceramic Raw Material Powder

Particles constituting the ceramic raw material powder used in the film forming apparatus 1 preferably have a density of 4.0 g/cm³ or more, and such particles include, for example, particles of stabilized zirconia in which yttrium, calcium, magnesium, hafnium, or the like is contained in zirconia. Note that in this embodiment, yttrium-containing zirconia (YSZ) is used as the ceramic raw material powder.

Film Formation Method

Next, the process of forming a film (formed film) on the base material K through the film forming method using the film forming apparatus 1 will be described. In the film forming method according to the present embodiment, the carrier gas is supplied from the gas supply section 16 to the aerosol generating section 6 while the carrier gas pressure control unit 17 and the carrier gas flow rate control unit 18 adjust the flow rate and pressure of the carrier gas flowing through the carrier gas feeding pipe S2. The aerosol generating section 6 generates an aerosol in which the fed carrier gas and the ceramic raw material powder supplied from the raw material powder supply section 7 are mixed. The generated aerosol is fed to the aerosol transport pipe 10.

The aerosol fed to the aerosol transport pipe 10 is ejected from the ejection end 10a of the aerosol transport pipe 10 toward the base material K, and the ejected aerosol collides with the base material K to form a film on the base material K.

Here, the aerosol ejected toward the base material K is ejected from the ejection end 10a having a circular flow path cross section, and the above (A1/Ia²) value is 0.95 (that is, 0.001 or more). Accordingly, the ejected aerosol has a uniform speed in the flow path cross section of the ejection end 10a, and variation in particle speed in the direction perpendicular to the base material K at the time of collision with the base material K is less likely to occur. For this reason, adhesion of a powder compact and formation of porosity are suppressed, and a homogeneous and dense film is formed. In particular, when the ceramic raw material powder is a stabilized zirconia such as YSZ, which has a relatively high density, a highly dense and homogeneous film can be formed. In addition, since the flow path cross-sectional area A1 of the ejection end 10a is 95 mm² (i.e., 10 mm² or more), the ceramic raw material powder is less likely to accumulate at the ejection end 10a, and a large amount of ceramic raw material powder can be stably supplied for a long time, and therefore it is possible to form a film on the base material K over a long period of time.

Working Examples 1 to 5 and Comparative Examples 1 to 4 will be described below. Film formation was performed for a predetermined time while moving the base material back and forth along a predetermined direction with different shapes of the flow path cross-section at the ejection end of the aerosol transport pipe, different flow path cross-sectional areas, and different distances between the ejection end and the base material. YSZ particles having a density of 5.9 g/cm³ and a median diameter of 1.01 μm were used as the raw ceramic powder in each of the working examples and comparative examples. Also, the flow rate of the carrier gas was set to 18 L/min, and the pressure in the processing chamber was set to 0.2 kPa in each working example and each comparative example.

Tables 1 to 3 are tables summarizing various conditions and results for Working Examples 1 to 5 and Comparative Examples 1 to 4, and “area of porous region” in Table 2 shows the area of a porous region with a low adhesive strength.

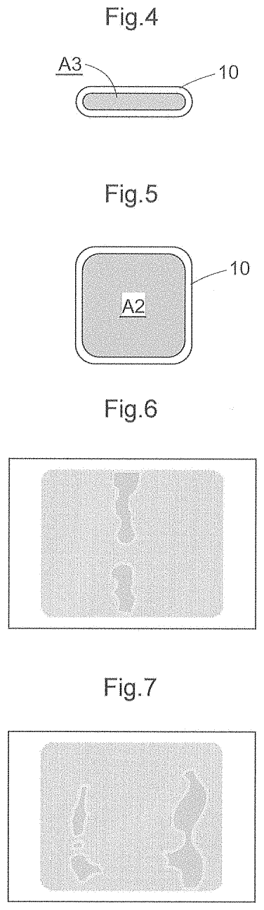

Also, FIG. 4 is a diagram showing the ejection end of the nozzle used in Comparative Example 1, and the area of the A3 portion indicated by shading in FIG. 4 is the flow path cross-sectional area. The shape of the nozzle used in Comparative Example 1 is a shape conventionally adopted as the shape of the nozzle of an apparatus for performing film formation processing through the AD method.
Furthermore, FIG. 5 is a diagram showing the ejection end of the nozzle used in Comparative Example 2, and the area of the A2 portion indicated by shading in FIG. 5 is the flow path cross-sectional area. FIG. 6 is a diagram schematically showing the base material after the film formation processing in Comparative Example 1, and the up-down direction in FIG. 6 is the movement direction of the base material. Also, FIG. 7 is a diagram schematically showing the base material after the film forming processing in Comparative Example 2, and, similarly to the above, the up-down direction in FIG. 7 is the movement direction of the base material. Note that in FIGS. 6 and 7, the dark shaded portions are the portions where a powder compact is adhered.

TABLE 1

| | Work. | Work. | Comp. | Comp. |
|---|---|---|---|---|
| | Ex. 1 | Ex. 2 | Ex. 1 | Ex. 2 |
| Flow path cross- | Circular | Circular | Slit-shaped | Square |
| sectional shape | (11 mm φ) | (11 mm φ) | (10 mm × | (10 mm |
| | | | 0.6 mm) | square) |
| Flow path cross- | 95 | 95 | 6 | 100 |
| sectional area | | | | |
| (mm²) | | | | |
| Distance between | 10 | 40 | 10 | 10 |
| ejection end and | | | | |
| base material | | | | |
| (mm) | | | | |
| (A1/Ia²) value | 0.950 | 0.059 | 0.060 | 1 |
| Adhesion state of | Not adhered | Not adhered | Adhered | Adhered |
| powder compact | | | | |

TABLE 2

| | Work. | Work. | Work. |
|---|---|---|---|
| | Ex. 3 | Ex. 4 | Ex. 5 |
| Flow path cross-sectional | Circular | Circular | Circular |
| shape | (5.5 mm φ) | (5.5 mm φ) | (5.5 mm φ) |
| Flow path cross-sectional area | 23.75 | 23.75 | 23.75 |
| (mm²) | | | |
| Distance between ejection end | 10 | 40 | 60 |
| and base material (mm) | | | |
| (A1/Ia²) value | 0.237 | 0.015 | 0.007 |
| Area of porous region (mm²) | 56 | 336 | 364 |
| Adhesion state of powder | Not adhered | Not adhered | Not adhered |
| compact | | | |

TABLE 3

| | Comp. Ex. 3 | Comp. Ex. 4 |
|---|---|---|
| Flow path cross-sectional shape | Circular | Circular |
| | (2.25 mm φ) | (2.25 mm φ) |
| Flow path cross-sectional shape (mm²) | 3.97 | 3.97 |
| Distance between ejection end and base | 10 | 5 |
| material (mm) | | |
| (A1/Ia²) value | 0.040 | 0.159 |
| Adhesion state of powder compact | Adhered | Adhered |

As can be understood from Table 1, when comparing Working Examples 1 and 2 with Comparative Examples 1 and 2, no adhesion of the powder compact was observed in Working Examples 1 and 2, whereas a large amount of powder compact was adhered in Comparative Examples 1 and 2 (see FIGS. 6 and 7). For example, as shown in FIG. 7, in Comparative Example 2, when the film formation processing is performed while the base material is moved back and forth, a large amount of the powder compact is adhered to the portion where the particles in the aerosol sprayed toward the base material from the corner portion where the flow of the aerosol is likely to be disturbed.

Based on these findings, it was confirmed that by making the cross-sectional shape of the ejection end of the aerosol transport path circular instead of square or slit-shaped as in the conventional technique, the flow speed of the aerosol becomes uniform within the flow path cross-section, and a uniform film can be formed on the base material.

Also, as shown in Table 2, even in Working Examples 3 to 5, in which the cross-sectional areas of the flow paths are slightly smaller than those in Working Examples 1 and 2, adhesion of the powder compact is not observed. On the other hand, regarding Working Examples 3 to 5, when the area of the porous region is focused on, it can be understood that the area of the porous region decreases and the uniformity of the film improves the higher the (A1/Ia²) value is.

Also, as shown in Table 3, in Comparative Examples 3 and 4, in which the cross-sectional areas of the flow paths are smaller than those of Working Examples 3 to 5, a large amount of the powder compact was adhered to the base material even though the cross-sectional shape of the flow path was circular. It is assumed that this is because even if the cross-sectional shape of the flow path is circular, the raw material powder will be clogged if the cross-sectional area of the flow path is too small. Due to this, it was confirmed that even if the channel cross-sectional shape is circular, a flow path cross-sectional area of a certain degree is required in order to suppress the formation of the powder compact and form a homogeneous film on the base material, and if the flow path cross-sectional area is too small, a homogeneous film cannot be formed on the base material.

Due to the above, it was confirmed that, as in the film forming apparatus 1 and the film forming method according to the present embodiment, by using an aerosol transport pipe 10 in which the flow path cross-section at the ejection end 10a is circular with an area of 10 mm² or more, a large amount of ceramic raw material powder can be stably supplied for a long time, and a homogeneous film can be formed.

### Other Embodiments

[1] In the above embodiment, the flow path cross-sectional area A1 at the ejection end 10a of the aerosol transport pipe 10 was 10 mm² or more, and the (A1/Ia²) value was 0.001 or more, but there is no limitation to this. If the flow path cross-sectional area A1 is 10 mm² or more, the (A1/Ia²) value does not need to be 0.001 or more.

[2] In the above embodiment, the distance from the ejection end 10a of the aerosol transport pipe 10 to the base material K was 100 mm or less, but there is no limitation to this as long as the flow path cross-sectional area A1 is 10 mm² or more. In particular, if the cross-sectional area A1 of the flow path is 10 mm² or more and the (A1/Ia²) value is 0.001 or more, variation in the particle speed in the direction perpendicular to the base material at the time of collision with the base material is less likely to occur, and therefore the effect of suppressing adhesion of a powder compact and formation of porosity is obtained.

[3] In the above embodiment, the aerosol transport pipe 10 was a cylindrical straight pipe member, but there is no limitation to this. Even if a crushing mechanism for crushing aggregated particles, a classifying mechanism for classifying particles, or the like is separately provided in the path of the straight pipe member, the flowability of the aerosol is not impaired, and therefore it is possible to stably supply a large amount of ceramic raw material powder for a long time. As long as the shape of the flow path cross-section at the ejection end 10a of the aerosol transport tube 10 is substantially circular, the straight tube member need not be used. Note that the substantially circular shape includes not only a perfect circle but also an elliptical shape. The substantially circular shape also includes triangles and polygons with curved corners, the polygons having a number of corners greater than or equal to that of a pentagon, and quadrilaterals with curved corners in which the ratio (r/R) of a radius r of a curved surface portion of a corner of the quadrilateral and the radius R of a circumscribing circle exceeds 0.3. In such a case as well, the flow speed of the aerosol at the ejection end becomes uniform within the cross section of the flow path, and therefore the effect of forming a homogeneous and dense film on the base material can be obtained.

[4] In the above embodiment, the flow path cross-section at the processing chamber internal transport section 10b of the aerosol transport pipe 10 and the flow path cross-section at the ejection end 10a were both circular with the same flow path cross-sectional area A1, but there is no limitation to this, and the shapes of both flow path cross-sections may be different from each other. For example, the shape of the flow path cross-section at the ejection end 10a may be circular, and the shape of the flow path cross-section at the processing chamber internal transport section 10b need not be circular, and the shapes of both flow path cross-sections may both be circular and have different areas. Note that the area of the flow path cross-section in the processing chamber internal transport section 10b of the aerosol transport pipe 10 is preferably 10 mm² or more, more preferably 20 mm² or more, more preferably 30 mm² or more, and even more preferably 95 mm² or more.

[5] In the above embodiment, the processing chamber was depressurized to 0.6 kPa or less, but the present invention is not limited to this.

The configurations disclosed in the above embodiments (including other embodiments) can be applied in combination with configurations disclosed in other embodiments as long as there is no contradiction, and the embodiment described in the present specification is an example, the embodiment of the present invention is not limited thereto, and can be modified as appropriate without departing from the object of the present invention.

### INDUSTRIAL APPLICABILITY

The present invention can be applied to a film forming apparatus and film forming method for forming a film on a base material, and a formed film.

### DESCRIPTION OF REFERENCE SIGNS

1 Film forming apparatus
10 Aerosol transport pipe (aerosol transport path)
10a Ejection end
10b Processing chamber internal transport section
K Base material

1. A film forming apparatus for forming a film on a base material, comprising:
an aerosol transport path for ejecting an aerosol obtained by dispersing a ceramic raw material powder in a gas, from an ejection end toward the base material, and
wherein a flow path cross-section at the ejection end of the aerosol transport path has a substantially circular shape with an area of 10 mm² or more.

2. The film forming apparatus according to claim 1,
wherein a distance from the ejection end of the aerosol transport path to the base material is 100 mm or less.

3. The film forming apparatus according to claim 1,
wherein a value obtained by dividing the area of the flow path cross-section at the ejection end of the aerosol transport path by a square of a distance between the ejection end of the aerosol transport path and the base material is 0.001 or more.

4. The film forming apparatus according to claim 1, further comprising:
a processing chamber with an inner space in which at least a portion on a side of the ejection end of the aerosol transport path and the base material are arranged, and
wherein a flow path cross-section of the aerosol transport path at a processing chamber internal transport section located in the processing chamber has a substantially circular shape with an area of 10 mm² or more.

5. The film forming apparatus according to claim 4,
wherein the shape of the flow path cross-section at the processing chamber internal transport section corresponds to the shape of the flow path cross-section at the ejection end.

6. The film forming apparatus according to claim 4,
wherein a pressure in the processing chamber is 0.6 kPa or less.

7. The film forming apparatus according to claim 1,
wherein the aerosol transport path is a straight pipe member.

8. The film forming apparatus according to claim 1,
wherein a density of particles of the ceramic raw material powder is 4.0 g/cm³ or more.

9. The film forming apparatus according to claim 1,
wherein the ceramic raw material powder is stabilized zirconia.

10. A film forming method for forming a film on a base material comprising ejecting an aerosol obtained by dispersing a ceramic raw material powder in a gas, from an ejection end of an aerosol transport path toward the base material, and
wherein ejecting the aerosol toward the base material from the ejection end has a flow path cross-section that has a substantially circular shape with an area of 10 mm² or more.

11. The film forming method according to claim 10,
wherein a distance from the ejection end of the aerosol transport path to the base material is 100 mm or less.

12. The film forming method according to claim 10,
wherein a value obtained by dividing a flow path cross-sectional area at the ejection end of the aerosol transport path by a square of a distance between the ejection end of the aerosol transport path and the base material is 0.001 or more.

13. The film forming method according to claim 10, further comprising:
arranging at least a portion on a side of the ejection end of the aerosol transport path and the base material in an inner space of a processing chamber, and
ejecting the aerosol toward the base material from the ejection end of the aerosol transport path in which a flow path cross-section at a processing chamber internal transport section located in the processing chamber has a substantially circular shape with an area of 10 mm² or more.

14. The film forming method according to claim 13,
wherein the shape of the flow path cross-section at the processing chamber internal transport section corresponds to the shape of the flow path cross-section at the ejection end.

15. The film forming method according to claim 13,
wherein a pressure in the processing chamber is 0.6 kPa or less.

16. The film forming method according to claim 10,
wherein the aerosol transport path is a straight pipe member.

17. The film forming method according to claim 10,
wherein a density of particles of the ceramic raw material powder is 4.0 g/cm³ or more.

18. The film forming method according to claim 10,
wherein the ceramic raw material powder is stabilized zirconia.

19. A formed film formed by the film forming apparatus according to claim 1.

20. A formed film formed through the film forming method according to claim 10.
